(19) United States
(12) Patent Application Publication
(10) Pub. No.: US 2008/0271762 A1
(43) Pub. Date: Nov. 6, 2008

(54) ETCHING GAS CONTROL SYSTEM

(75) Inventors: Kun Joo PARK, Suwon-city (KR); Hwan Kook CHAE, Suwon-city (KR); Byoungil LEE, Suwon-city (KR); Kee Hyun KIM, Suwon (KR); Weon Mook LEE, Suwon-city (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: DMS CO., LTD., Suwon-city (KR)

(21) Appl. No.: 12/061,303

(22) Filed: Apr. 2, 2008

(30) Foreign Application Priority Data
May 4, 2007 (KR) 1020070043432

(51) Int. Cl. B08B 5/00

(52) U.S. Cl. 134/98.1; 134/200; 134/99.1

(57) ABSTRACT

An etching gas control system is provided. The system includes a gas injector, a gas supply pipe, a Flow Ratio Controller (FRC), and a gas supply unit. The gas injector is installed in a chamber and supplies gas inside the chamber. The gas injector includes a top injector installed at a top of the chamber and a side injector installed at a side of the chamber. The gas supply pipe connects and supplies gas to the gas injector. The FRC connects to the gas supply pipe and controls supply of gas. The gas supply unit supplies gas to the FRC.

### BACKGROUND OF THE INVENTION

1. Field of the Invention

The present invention relates to an etching gas control system of an etching equipment that is used for an etching process of a manufacturing process of a semiconductor integrated circuit. More particularly, the present invention relates to an etching gas control system configured to install gas injectors at the top and the side of a chamber in which a wafer is installed, supply etching gas in a top direction and a side direction of the wafer, cross connect and dispose gas supply pipes for supplying etching gas and auxiliary gas to the gas injectors, and selectively variously control an amount and flow of etching gas injected and supplied to the chamber, thereby controlling an ion density and distribution of etching gas within the chamber and improving an etching rate and etching uniformity of a wafer surface.

2. Description of the Related Art

In general, a semiconductor integrated circuit device has a circuit of a complex structure by forming an ultra fine structure of a desired type on a surface through selective removal of only part of a wafer or a thin film deposited on the wafer. A thin film is manufactured through several manufacturing processes such as a washing process, a deposition process, a photolithography process, a plating process, an etching process, etc.

Among a variety of manufacturing processes, the etching process is a process of removing a desired target from a wafer surface using a chemical reaction by injecting etching gas (CF₄, Cl₂, HBr, etc.) into a chamber in which a wafer is installed, using a gas injector. Through the etching process, a fine circuit pattern is formed on a substrate by selectively removing a portion that is not covered with a photoresist, using a photoresist pattern that is formed in the photolithography process as a mask.

Thus, it is important to form the same thin-film pattern as a photoresist pattern by maintaining the whole wafer surface at the same etching rate and forming an etched section in a right-angle shape.

However, during the etching process, because an etching speed is different due to chemical reaction and partial overetching occurs, an etching rate of the whole wafer surface is made non-uniform or the scattering of ions within plasma leads to the occurrence of the undercut phenomenon in a thin film underlying a photoresist.

In order to solve this, in a conventional etching gas control device, a gas injector is installed at the top of a chamber of an etching equipment and etching gas is supplied to the gas injector through a Flow Ratio Controller (FRC) that connects to a gas supply unit. By doing so, an amount of etching gas supplied inside the chamber is controlled and etching is performed.

However, the conventional etching gas control device had problems as follows.

First, etching gas is injected and supplied through the gas injector, which is installed only at the top of the chamber, inside the chamber and is controlled in amount by the FRC that connects to the gas supply pipe. Thus, there was a limitation in providing an optimal etching rate and etching uniformity for a wide surface of a large-scaled wafer of 12 inches (300 mm). Second, auxiliary gas such as Argon (Ar), helium (He), and Xenon (Xe), plasma activation gas, cannot be controlled independently in addition to an amount and flow of etching gas cannot be controlled variously. Thus, there was a problem that the ion density or distribution of etching gas within the chamber cannot be kept optimal.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide an etching gas control system that is configured to install gas injectors at the side and the top of a chamber in which a wafer is installed, and selectively variously control an amount and flow of etching gas injected in a top direction and a side direction of the wafer.

Another aspect of exemplary embodiments of the present invention is to provide an etching gas control system that is configured to include an auxiliary gas supply unit that can be independently controlled, cross connect and dispose gas supply pipes for supplying etching gas and auxiliary gas, and variously control an amount and flow of etching gas and auxiliary gas, thereby controlling the ion density and distribution of etching gas within a chamber and optimizing an etching rate and etching uniformity of a wafer surface.

According to one aspect of the present invention, an etching gas control system is provided. The system includes a gas injector, a gas supply pipe, a Flow Ratio Controller (FRC), and a gas supply unit. The gas injector is installed in a chamber and supplies gas inside the chamber within which a wafer is installed. The gas injector includes a top injector installed at a top of the chamber and supplying gas in a top direction of the wafer and a side injector installed at a side of the chamber and supplying gas in a side direction of the wafer. The gas supply pipe connects and supplies gas to the gas injector. The FRC connects to the gas supply pipe and controls supply of gas. The gas supply unit supplies gas to the FRC.

The gas supply pipe may include a first supply pipe and a second supply pipe each connecting to the top injector and the side injector.

The gas supply unit may include an etching gas supply unit for supplying etching gas and an auxiliary gas supply unit for supplying auxiliary gas. The auxiliary gas supply unit may include a Mass Flow Controller (MFC) and an ON/OFF valve for independently controlling auxiliary gas.

The top injector may include an inner nozzle for jetting gas in a front direction and an outer nozzle for jetting gas in a side direction. The first supply pipe may connect to the inner nozzle. A first branch pipe may be installed at the second supply pipe and connect a third supply pipe and a fourth supply pipe to the outer nozzle and the side injector, respectively.

The first, third, and fourth supply pipes each may have ON/OFF valves for opening and closing a path of gas.

A second branch pipe may be installed at the first supply pipe between the ON/OFF valve and the FRC. A third branch pipe may be installed at the third supply pipe between the ON/OFF valve and the top injector. A connection pipe may be installed between the first and third supply pipes and may connect the second branch pipe with the third branch pipe.

The connection pipe may have an ON/OFF valve for opening and closing a path of gas.

A fifth branch pipe may be installed at the first supply pipe between the ON/OFF valve and the top injector. A fifth supply pipe may be installed to connect the MFC with the fifth branch pipe. A fourth branch pipe may be installed at the fifth supply pipe. A sixth branch pipe may be installed at the third supply pipe between the third branch pipe of the third supply pipe and the top injector. A sixth supply pipe may be installed to connect the fourth branch pipe with the sixth branch pipe.

A seventh branch pipe may be installed at the fourth supply pipe between the ON/OFF valve and the side injector. A seventh supply pipe may be further installed at the fifth supply pipe to connect the fourth branch pipe with the seventh branch pipe.

The sixth supply pipe and a section of the fifth supply pipe between the fourth branch pipe and the fifth branch pipe each may include ON/OFF valves.

The seventh supply pipe may include an ON/OFF valve for opening and closing a path of gas.

The fifth supply pipe may further include an ON/OFF valve for opening and closing a path of gas between the MFC of the auxiliary gas supply unit and the fourth branch pipe.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram illustrating an etching gas control system according to an exemplary embodiment of the present invention;

FIG. 2 is an arrangement diagram illustrating gas supply pipes in an etching gas control system according to an exemplary embodiment of the present invention;

FIG. 3 is an arrangement diagram illustrating a state where a gas supply unit of FIG. 2 further includes an auxiliary gas supply unit;

FIG. 4 is a cross section illustrating a gas injector of the etching gas control system of FIGS. 2 and 3;

FIG. 5 is an arrangement diagram illustrating a state where ON/OFF valves each are installed at gas supply pipes of FIG. 4;

FIG. 6 is an arrangement diagram illustrating a state where a connection pipe is provided between a first supply pipe and a third supply pipe in an etching gas control system according to an exemplary embodiment of the present invention;

FIG. 7 is an arrangement diagram illustrating gas supply pipes that connect an auxiliary gas supply unit with a top injector of FIG. 6;

FIG. 8 is an arrangement diagram illustrating a state where a side injector further connects to the auxiliary gas supply unit of FIG. 7; and

FIG. 9 is an arrangement diagram illustrating a state where ON/OFF valves each are installed at gas supply pipes connecting to the auxiliary gas supply unit of FIG. 8.

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. In the following description, a detailed description of known functions and configurations incorporated herein has been omitted for conciseness.

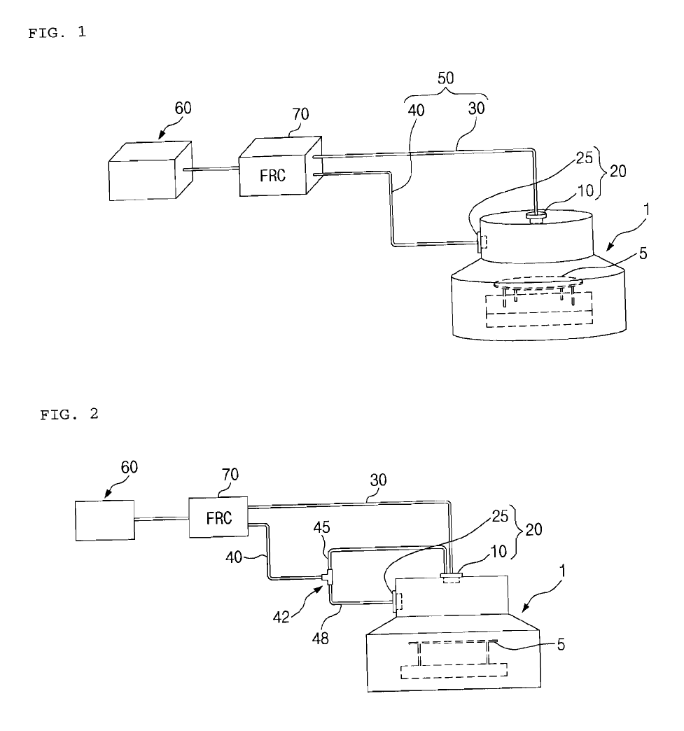

FIG. 1 is a schematic diagram illustrating an etching gas control system according to an exemplary embodiment of the present invention.

As shown in FIG. 1, the etching gas control system includes a gas injector 20, a gas supply pipe 50, a Flow Ratio Controller (FRC) 70, and a gas supply unit 60.

The gas injector 20 injects etching gas inside a chamber 1 in which a wafer is installed. The gas injector 20 includes a top injector 10 installed at a top and central part of the chamber 1 and a side injector 25 installed at a side part of the chamber 1.

The side injector 25 can be installed in plurality so that they are at a distance along an outer periphery of the side part of the chamber 1.

The gas supply pipe 50 includes a first supply pipe 30 and a second supply pipe 40. The first and second supply pipes 30 and 40 each connect at one ends for gas supply to the top injector 10 and the side injector 25 and connect at the other ends to the FRC 70.

The FRC 70 connecting with the gas supply unit 60 introduces gas from the gas supply unit 60 and supplies the introduced gas to the top injector 10 and the side injector 25 through the first supply pipe 30 and the second supply pipe 40, respectively. The FRC 70 variously control and supplies gas by varying an amount of gas supplied to the top injector 10 and the side injector 25.

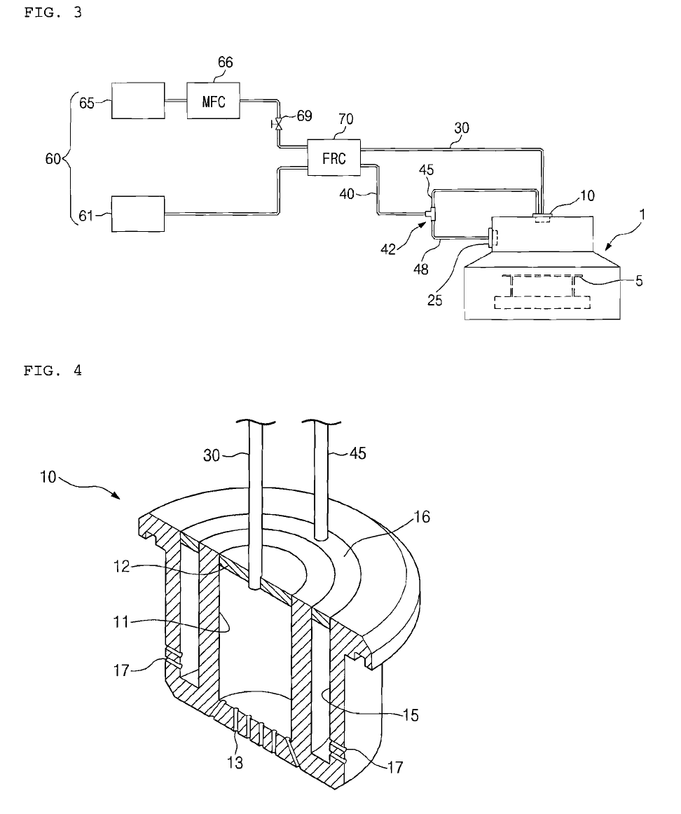

FIG. 2 is an arrangement diagram illustrating gas supply pipes in an etching gas control system according to an exemplary embodiment of the present invention. FIG. 3 is an arrangement diagram illustrating a state where a gas supply unit of FIG. 2 further includes an auxiliary gas supply unit. FIG. 4 is a cross section illustrating a gas injector of the etching gas control system of FIGS. 2 and 3.

As shown in FIG. 4, the top injector 10 includes an inner gas inlet hole 11, an inner nozzle 13, an outer gas inlet hole 15, and an outer nozzle 17. The inner gas inlet hole 11 is provided at a central part of the top injector 10. The inner nozzle 13 is formed in a penetrating fashion at a lower part of the inner gas inlet hole 11. The outer gas inlet hole 15 is provided to be at a distance from along a periphery of the inner gas inlet hole 11. The outer nozzle 17 is formed in a penetrating fashion at a lower part of the outer gas inlet hole 15 and injects gas in a side direction.

The inner nozzle 13 and the outer nozzle 17 can be formed in plurality. Also, the inner nozzle 13 and the outer nozzle 17 can be formed to be slant to a predetermined direction. Also, the outer nozzle 17 can be formed in plurality such that they are spaced apart from each other along an outer periphery of the outer gas inlet hole 15.

The top injector 10 includes sealing covers 12 and 16 each coupled to upper parts of the inner gas inlet hole 11 and the outer gas inlet hole 15.

The first supply pipe 30 is coupled to the sealing cover 12 coupled to the upper part of the inner gas inlet hole 11 such that gas can be supplied to the inner gas inlet hole 11 of the top injector 10.

As shown in FIG. 2, a first branch pipe 42 is installed at the second supply pipe 40 such that a third supply pipe 45 and a fourth supply pipe 48 branch from the second supply pipe 40. The third supply pipe 45 is coupled to the sealing cover 16 coupled to the upper part of the outer gas inlet hole 15 such that gas can be supplied to the outer gas inlet hole 15 of the top injector 10. The fourth supply pipe 48 connects to the side injector 25.

As shown in FIG. 3, the gas supply unit 60 includes an etching gas supply unit 61 for supplying etching gas and an auxiliary gas supply unit 65 for supplying auxiliary gas that activates a plasma state within the chamber 1.

The etching gas supply unit 61 and the auxiliary gas supply unit 65 each connect to the FRC 70 for gas supply. The auxiliary gas supply unit 65 connects to a Mass Flow Controller (MFC) 66 and an ON/OFF valve 69.

Thus, it is possible to diversely control an amount of etching gas supplied to the inner nozzle 13 and outer nozzle 17 of the top injector 10 and the side injector 25 because the FRC 70 relatively controls an amount of etching gas supplied to the first supply pipe 30 and the second supply pipe 40. Auxiliary gas is independently controlled using the MFC 66 and the ON/OFF valve 69 and is supplied to the FRC 70. Thus, the auxiliary gas can be mixed with etching gas.

FIG. 5 is an arrangement diagram illustrating a state where ON/OFF valves 39, 46, and 49 each are installed at the first, third, and fourth gas supply pipes 30, 45, and 48 of FIG. 4. Referring to FIG. 5, the ON/OFF valves 39, 46, and 49 block or pass a mixture of etching gas and auxiliary gas supplied to the inner nozzle 13 and outer nozzle 17 of the top injector 10 and the side injector 25.

Thus, the ON/OFF valves 39, 46, and 49 can selectively control an amount and flow of gas supplied inside the chamber 1.

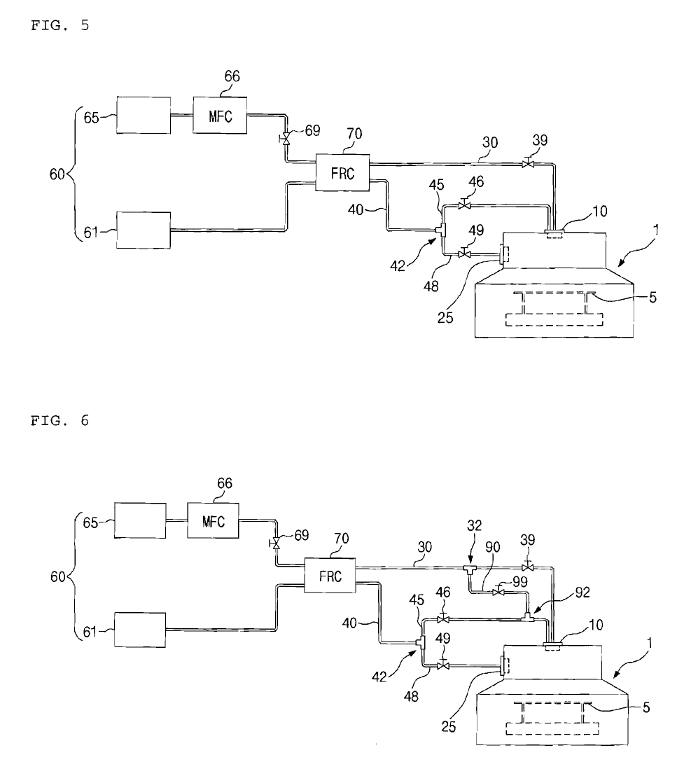

FIG. 6 is an arrangement diagram illustrating a state where a connection pipe connects the first supply pipe with the third supply pipe in the etching gas control system according to an exemplary embodiment of the present invention.

As shown in FIG. 6, a second branch pipe 32 is installed at the first supply pipe 30 between the FRC 70 and the ON/OFF valve 39. A third branch pipe 92 is installed at the third supply pipe 45 between the top injector 10 and the ON/OFF valve 46. A connection pipe 90 connecting the first and third supply pipes 30 and 45 is further provided between the second branch pipe 32 and the third branch pipe 92.

Thus, by communicating, by the connection pipe 90, the first and third supply pipes 30 and 45 independently supplying gas, it is possible not only to enable the ON/OFF valves 39 and 46 each installed at the first and third supply pipes 30 and 45 to change a flow of gas supplied to the inner nozzle 13 and the outer nozzle 17 of the top injector 10 among gas supplied inside the chamber 1 but also to variously control an amount of gas supplied.

The flow of gas can be blocked using an ON/OFF valve 99 installed at the connection pipe 90.

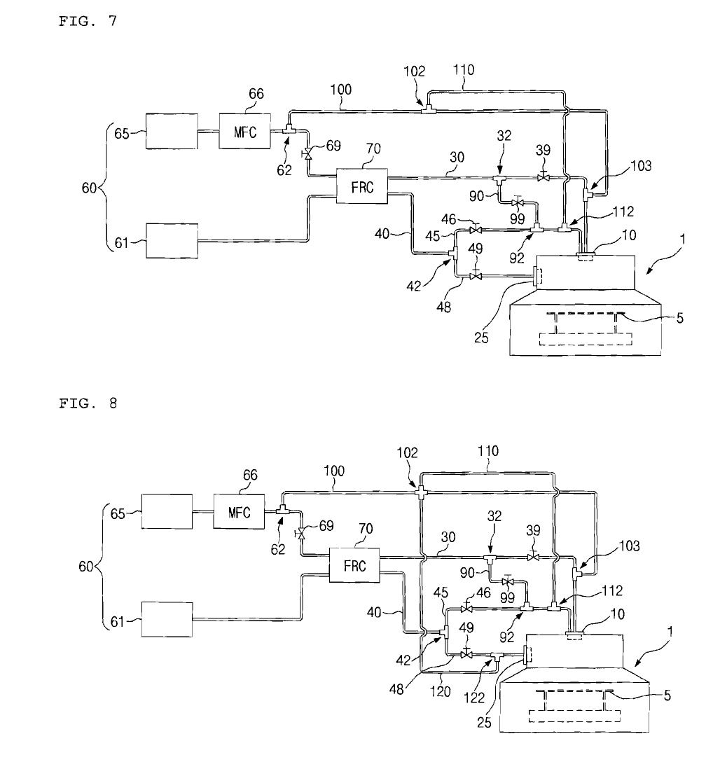

FIG. 7 is an arrangement diagram illustrating another example where gas supply pipes are further provided and connect the auxiliary gas supply unit with the top injector in the etching gas control system.

As shown in FIG. 7, an eighth branch pipe 62 is installed between the MFC 66 provided for the auxiliary gas supply unit 65 and the ON/OFF valve 69. A fifth branch pipe 103 is installed at the first supply pipe 30 between the ON/OFF valve 39 and the top injector 10. A fifth supply pipe 100 is provided between the eighth branch pipe 62 and the fifth branch pipe 103 and connects the MFC 66 with the first supply pipe 30.

A fourth branch pipe 102 is installed at the fifth supply pipe 100. A sixth branch pipe 112 is installed between the ON/OFF valve 46 of the third supply pipe 45 and the top injector 10. A sixth supply pipe 110 is provided between the fourth branch pipe 102 and the sixth branch pipe 112 and connects the fifth supply pipe 100 with the third supply pipe 45.

Thus, auxiliary gas, which is a plasma activation gas, is independently controlled by the MFC 66 and directly supplied to the first supply pipe 30 and the third supply pipe 45 without mixing with etching gas in the FRC 70. By doing so, the auxiliary gas can be supplied only to the inner nozzle 13 and outer nozzle 17 of the top injector 10 under independent control of the MFC 66.

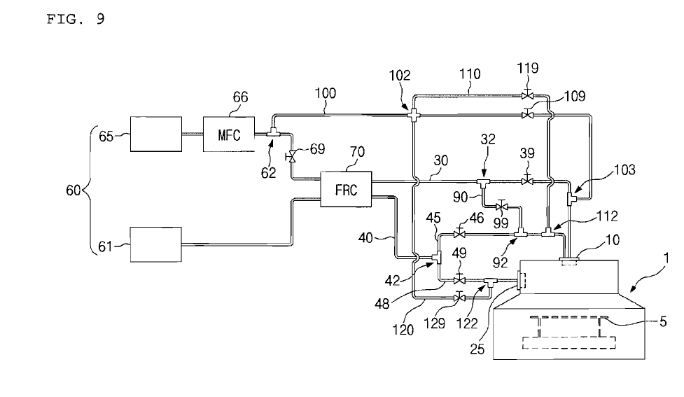

FIG. 8 is an arrangement diagram illustrating a state where the fifth supply pipe and the fourth supply pipe of FIG. 7 connect with each other. FIG. 9 is an arrangement diagram illustrating a state where ON/OFF valves each are installed at the fifth and sixth supply pipes and a seventh gas supply pipe connecting to the auxiliary gas supply unit of FIG. 8.

As shown in FIGS. 8 and 9, a seventh branch pipe 122 is installed between the ON/OFF valve 49 of the fourth supply pipe 48 and the side injector 25. A seventh supply pipe 120 is further provided for the fifth supply pipe 100 and connects the fourth branch pipe 102 and the seventh branch pipe 122.

Thus, auxiliary gas can be independently controlled by the MFC 66 and supplied to the side injector 25 as well as the top injector 10.

Further, auxiliary gas can be not only independently controlled by the MFC 66 but also can be selectively supplied by diversely controlling an amount and flow of the auxiliary gas supplied to the inner nozzle 13 and outer nozzle 17 of the top injector and the side injector 25 using ON/OFF valves 109, 119, 129 each installed at the fifth, sixth, and seventh supply pipes 100, 110, and 120.

An ON/OFF valve (not shown) is further installed between the eighth branch pipe 62 and the fourth branch pipe 102 and can concurrently block auxiliary gas supplied to the fifth, sixth, and seventh supply pipes 100, 110, and 120.

An example of controlling supply of etching gas and auxiliary gas in the etching gas control system is described with reference to Table 1 below.

TABLE 1

| | | | Etching gas | | | | Auxiliary gas | | |
|---|---|---|---|---|---|---|---|---|---|
| | | | | | | Side | | | Side |
| | FRC | | Top injector | | | injector | Top injector | | injector |
| | 1^{st} | 2^{nd} | 1^{st} | 3^{rd} | | 4^{th} | 5^{th} | 6^{th} | 7^{th} |
| | supply | supply | supply | supply | Connection | supply | supply | supply | supply |
| Split | pipe | pipe | pipe | pipe | pipe | pipe | pipe | pipe | pipe |
| 1 | 1 to 9 | 1 to 9 | ON | ON | | | | | |
| 2 | 1 to 9 | 1 to 9 | ON | | ON | ON | | | |
| 3 | 1 to 9 | 1 to 9 | ON | | | | | | |
| 4 | 1 to 9 | 1 to 9 | | ON | | | | | |
| 5 | 1 to 9 | 1 to 9 | | | | ON | | | |
| 6 | 1 to 9 | 1 to 9 | | | ON | ON | | | |
| 7 | 1 to 9 | 1 to 9 | | | ON | | | | |
| 8 | 1 to 9 | 1 to 9 | ON | ON | | ON | | | |
| 9 | 1 to 9 | 1 to 9 | | ON | | | ON | | |
| 10 | 1 to 9 | 1 to 9 | | | | ON | ON | ON | |
| 11 | 1 to 9 | 1 to 9 | | | ON | | ON | | |
| 12 | 1 to 9 | 1 to 9 | | | ON | ON | ON | | |
| 13 | 1 to 9 | 1 to 9 | | ON | | | ON | | ON |
| 14 | 1 to 9 | 1 to 9 | ON | | | | | ON | |
| 15 | 1 to 9 | 1 to 9 | | | | ON | | ON | |
| 16 | 1 to 9 | 1 to 9 | ON | | | | | ON | ON |
| 17 | 1 to 9 | 1 to 9 | ON | | | ON | | ON | |
| 18 | 1 to 9 | 1 to 9 | ON | ON | | | | | ON |
| 19 | 1 to 9 | 1 to 9 | ON | | | | | | ON |
| 20 | 1 to 9 | 1 to 9 | | | ON | | | | ON |

Table 1 shows typical examples of 20 splits of states where etching gas and auxiliary gas are selectively supplied to the inner nozzle 13 and outer nozzle 17 of the top injector 10 and the side injector 25 using the FRC 70 and the ON/OFF valves 39, 46, 49, 69, 99, 109, 119, and 129 each installed at the gas supply pipes.

The FRC 70 can control and supply gas, which is introduced from the gas supply unit 60, to the first supply pipe 30 and the second supply pipe 40 at a relatively different rate.

That is, assuming that a total of introduced gas is equal to 10, gas can be either supplied to the first supply pipe 30 and the second supply pipe 40 at a ratio of 1 to 9 or can be supplied to the first supply pipe 30 and the second supply pipe 40 at a ratio of 2 to 8. Thus, gas can be relatively variously controlled in amount and supplied to the first supply pipe 30 and the second supply pipe 40.

In the 20 splits of Table 1, wordings of ‘ON’ represent states where the ON/OFF valves 39, 46, 49, 69, 99, 109, 119, and 129 are opened and thus, etching gas and auxiliary gas are supplied. Blanks with no wordings represent ‘OFF’ states of the ON/OFF valves 39, 46, 49, 69, 99, 109, 119, and 129 indicating no flow of gas.

‘1’, ‘2’, and ‘9’ splits of the 20 splits are described below, for example.

The ‘1’ split of Table 1 represents a state where the first supply pipe 30 and the third supply pipe 45 are opened and the fourth, fifth, sixth, seventh supply pipes and the connection pipe 90 are closed. In this state, etching gas is supplied to the inner nozzle 13 of the top injector 10 through the first supply pipe 30 and is supplied to the outer nozzle 17 through the second and third supply pipes 40 and 45.

Thus, etching gas is supplied only to the inner nozzle 13 and outer nozzle 17 of the top injector 10 with no auxiliary gas supplied.

At this time, even an amount of gas supplied to the inner nozzle 13 and outer nozzle 17 of the top injector 10 can be variously controlled by relatively controlling an amount of gas supplied to the first and second supply pipes 30 and 40 using the FRC 70.

The ‘2’ split of Table 1 represents a state where only the first and fourth supply pipes 30 and 48 and the connection pipe 90 are opened. The half of etching gas is supplied to the inner nozzle 13 through the first supply pipe 30. The other half is supplied to the outer nozzle 17 through the connection pipe 90 opened.

Gas supplied to the second supply pipe 40 is directly supplied to the side injector 25 through the fourth supply pipe 48.

Similarly with the ‘1’ split, in the ‘2’ split, an amount of gas supplied to the first and second supply pipes 30 and 40 can be diversely controlled using the FRC 70 as well.

The ‘9’ split of Table 1 represents that only the third supply pipe 45 and the fifth supply pipe 100 are opened. Therefore, etching gas is supplied only to the outer nozzle 17 of the top injector 10 through the second and third supply pipes 40 and 45. Auxiliary gas is supplied only to the inner nozzle 13 of the top injector 10 through the fifth supply nozzle 100.

An amount of etching gas and auxiliary gas can be controlled using the FRC 70 and the MFC 66.

Thus, as shown in Table 1, the present invention can diversely control an amount and flow of etching gas and auxiliary gas supplied to the inner nozzle 13 and outer nozzle 17 of the top injector 10 and the side injector 25. By this, the present invention can build the environment keeping the ion density or distribution of gas within the chamber 1 optimal, provide optimal etching rate, etching uniformity, and etched section for a surface of the wafer 5, and improve a quality of the wafer 5 as well as minimize a failure rate.

As described above, the present invention has an effect of being capable of improving an etching rate and etching uniformity for a surface of a wafer and minimizing a failure rate of the wafer by supplying etching gas to a side part as well as a top part of a chamber, variously controlling an amount and flow of etching gas and auxiliary gas through gas supply pipes that are connected with each other and arranged, controlling the ion density and distribution of etching gas and auxiliary gas within the chamber, and forming an optimal etching condition.

Also, the present invention has an effect of being capable of forming an etched section in a right-angle shape, forming the same thin-film pattern as a photoresist pattern, and improving performance of a semiconductor integrated circuit by providing an optimal etching condition within a chamber and preventing the undercut phenomenon that a thin film underlying a photoresist is etched unnecessarily.

While the invention has been shown and described with reference to a certain preferred embodiment thereof, it will be understood by those skilled in the art that various changes in form and details may be made therein without departing from the spirit and scope of the invention as defined by the appended claims.

1. An etching gas control system comprising:
a gas injector installed in a chamber and supplying gas inside the chamber within which a wafer is installed,
the gas injector comprising:
a top injector installed at a top of the chamber and supplying gas in a top direction of the wafer; and
a side injector installed at a side of the chamber and supplying gas in a side direction of the wafer;
a gas supply pipe connecting and supplying gas to the gas injector;
a Flow Ratio Controller (FRC) connecting to the gas supply pipe and controlling supply of gas; and
a gas supply unit for supplying gas to the FRC.

2. The system of claim 1, wherein the gas supply pipe comprises:
a first supply pipe and a second supply pipe each connecting to the top injector and the side injector.

3. The system of claim 1, wherein the gas supply unit comprises:
an etching gas supply unit for supplying etching gas; and
an auxiliary gas supply unit for supplying auxiliary gas, and
wherein the auxiliary gas supply unit comprises:
a Mass Flow Controller (MFC) and an ON/OFF valve for independently controlling auxiliary gas.

4. The system of claim 3, wherein the top injector comprises:
an inner nozzle for jetting gas in a front direction; and
an outer nozzle for jetting gas in a side direction,
wherein the first supply pipe connects to the inner nozzle, and
wherein a first branch pipe is installed at the second supply pipe and connects a third supply pipe and a fourth supply pipe to the outer nozzle and the side injector, respectively.

5. The system of claim 4, wherein the first, third, and fourth supply pipes each have ON/OFF valves for opening and closing a path of gas.

6. The system of claim 5, wherein a second branch pipe is installed at the first supply pipe between the ON/OFF valve and the FRC,
wherein a third branch pipe is installed at the third supply pipe between the ON/OFF valve and the top injector, and
wherein a connection pipe is installed between the first and third supply pipes and connects the second branch pipe with the third branch pipe.

7. The system of claim 6, wherein the connection pipe has an ON/OFF valve for opening and closing a path of gas.

8. The system of claim 7, wherein a fifth branch pipe is installed at the first supply pipe between the ON/OFF valve and the top injector,
wherein a fifth supply pipe is installed to connect the MFC with the fifth branch pipe,
wherein a fourth branch pipe is installed at the fifth supply pipe,
wherein a sixth branch pipe is installed at the third supply pipe between the third branch pipe of the third supply pipe and the top injector, and
wherein a sixth supply pipe is installed to connect the fourth branch pipe with the sixth branch pipe.

9. The system of claim 8, wherein a seventh branch pipe is installed at the fourth supply pipe between the ON/OFF valve and the side injector, and
wherein a seventh supply pipe is further installed at the fifth supply pipe to connect the fourth branch pipe with the seventh branch pipe.

10. The system of claim 9, wherein the sixth supply pipe and a section of the fifth supply pipe between the fourth branch pipe and the fifth branch pipe each comprises ON/OFF valves.

11. The system of claim 10, wherein the seventh supply pipe comprises an ON/OFF valve for opening and closing a path of gas.

12. The system of any one of claims 11, wherein the fifth supply pipe further comprises an ON/OFF valve for opening and closing a path of gas between the MFC of the auxiliary gas supply unit and the fourth branch pipe.

13. The system of claim 2, wherein the gas supply unit comprises:
an etching gas supply unit for supplying etching gas; and
an auxiliary gas supply unit for supplying auxiliary gas, and
wherein the auxiliary gas supply unit comprises:
a Mass Flow Controller (MFC) and an ON/OFF valve for independently controlling auxiliary gas.
